(19) United States
(12) Patent Application Publication
(10) Pub. No.: US 2016/0176138 A1
(43) Pub. Date: Jun. 23, 2016

(54) SLEEVELESS TIRE BUILDING DRUM

(71) Applicant: The Goodyear Tire & Rubber Company, Akron, OH (US)

(72) Inventor: Ivan Marcos ROA GUZMAN, Santiago (CL)

(21) Appl. No.: 14/924,111

(22) Filed: Oct. 27, 2015

Related U.S. Application Data
(60) Provisional application No. 62/095,830, filed on Dec. 23, 2014.

(51) Int. Cl. B29D 30/24

(52) U.S. Cl. CPC B29D 30/245

(57) ABSTRACT

A tire building drum and a method of building a tire carcass is disclosed. The tire building drum has a center section comprised of a plurality of segments that are radially and axially movable. The sleeve of the tire building drum over the center section has been eliminated, and instead has two seals located on the outer ends or shoulders of the center section of the tire building drum. The building drum further comprises shoulder sections that are axially movable. The shoulder sections include radially expandable bead locks. The method employs the steps of applying one or more carcass layers, locking the bead locks and moving the center section radially outwardly while moving the bead locks axially inwardly.

### FIELD OF THE INVENTION

The invention relates to a tire building drum, more particularly to a tire building drum with no center sleeve.

### BACKGROUND OF THE INVENTION

The manufacture of tires typically involves a tire building drum wherein numerous tire components are applied to the drum in sequence, forming a cylindrical shaped tire carcass. This stage of the tire building process is commonly referred to as the “first stage” of the tire building process. The tire carcass is then typically removed from the tire building drum and sent to a second stage, expandable tire shaping drum where the carcass is expanded into a toroidal shape for receipt of the remaining components of the tire such as the belt package and a rubber tread. The completed toroidally shape unvulcanized tire carcass or green tire is then removed from the second stage drum and subsequently molded and vulcanized into a finished tire.

The prior art process thus requires two tire building drums and the transfer of the carcass from one drum to the other. Further, a problem often arises in precisely locating and anchoring the tire beads on the unvulcanized tire carcass, especially during the transportation of the tire beads from the first stage drum to the second stage drum. Variations in bead positioning can result in ply distortion in the tire.

Tire manufacturers have recently begun moving towards the utilization of a single tire building drum, for both the first and second stage tire building. This requires that the tire building drum be capable of axial expansion and contraction as well as radial expansion/contraction. Further, it is important to maintain a positive bead lock during the entire tire building process, including the tire shaping, so that the ply cord length is maintained, resulting in good tire uniformity.

Tire manufacturers typically use a flexible cylindrical rubberized center sleeve as the outermost element on tire building drums. The center sleeve functions as the surface of application and point of fixation for the innermost component of the tire (innerliner). The section where the centersleeve wraps around the “shoulder” of the radially expansible segments also serves as a pneumatic seal against the bead area of the green tire, enabling inflation (shaping) of the green tire in the full-stage tire building process. The centersleeve also typically has a series of holes for providing a vacuum to secure the innerliner to the drum and the air to shape the green tire.

It is desired to remove the center sleeve because it is generally width specific. Removing the center sleeve allows a greater increase in manufacturing flexibility, as many different tire codes can be run on the same drum without the need to change parts. This results in increased machine uptime and a substantial reduction in drum inventory requirements. With the sleeveless modification, a special set of drum segments are needed so that the leading edge of the first tire component can be picked up by the drum. However, due to the removal of the center sleeve, it is difficult to use vacuum to efficiently pick up and secure the leading edge of a tire component. This is due to the lack of resiliency around the vacuum holes. Thus an improved tire building drum is desired which no longer requires a center sleeve, and has sufficient vacuum to adhere the first tire component to the drum without dimpling the tire component.

### DEFINITIONS

For ease of understanding this disclosure, the following items are defined:

“Apex” means an elastomeric filler located radially above the bead and interposed between the plies and the ply turn-up.

“Axial” and “axially” means the lines or directions that are parallel or aligned with the longitudinal axis of rotation of the tire building drum.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire building drum.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1 is a front cross-sectional view of a tire building drum of the present invention shown having two shoulder sleeves mounted on the crown portion of the drum.

FIG. 2 is a close-up cross-sectional view of the tire building drum of FIG. 1 showing the drum in the radially expanded position.

FIG. 3 is a close up cross-sectional view of a tire building drum in the expanded high crown condition shown with a prior art centersleeve.

FIG. 4 is a close up cross-sectional view of the tire building drum in the expanded high crown condition shown with the shoulder sleeves of the present invention.

FIG. 5 is a front view of the center section of the tire building drum in the axially contracted position.

FIG. 6 is a front view of the center section of the tire building drum in the axially expanded position.

FIG. 7 is a perspective view of the center section of the tire building drum shown in the axially contracted position.

FIG. 8 is a perspective view of the center section of the tire building drum shown in the axially contracted position and radially expanded position.

FIG. 9 is a perspective view of the center section in the axially expanded position of the tire building drum with the shoulder seals removed.

FIG. 10 is a cross sectional view of half of the center section of the tire building drum.

FIG. 11 is a top view of a single center section segment.

FIG. 12 is a bottom view of the single center section segment of FIG. 11.

FIG. 13 is a side view of the single center section segment of FIG. 11.

FIG. 14 is a perspective view of a splice bar segment.

FIG. 15 is a center section having a second embodiment of a splice bar assembly.

FIG. 16 is a perspective view of a splice bar assembly of the present invention.

FIG. 17 is a cross-sectional view of the splice bar assembly of the present invention.

FIG. 18 is an end view of the splice bar assembly of FIG. 17.

FIG. 19 illustrates the splice bar assembly in the axially retracted position.

FIG. 20a illustrates the right hand frame of the splice bar assembly and FIG. 20b illustrates the left hand frame of the splice bar assembly.

### DETAILED DESCRIPTION OF THE INVENTION

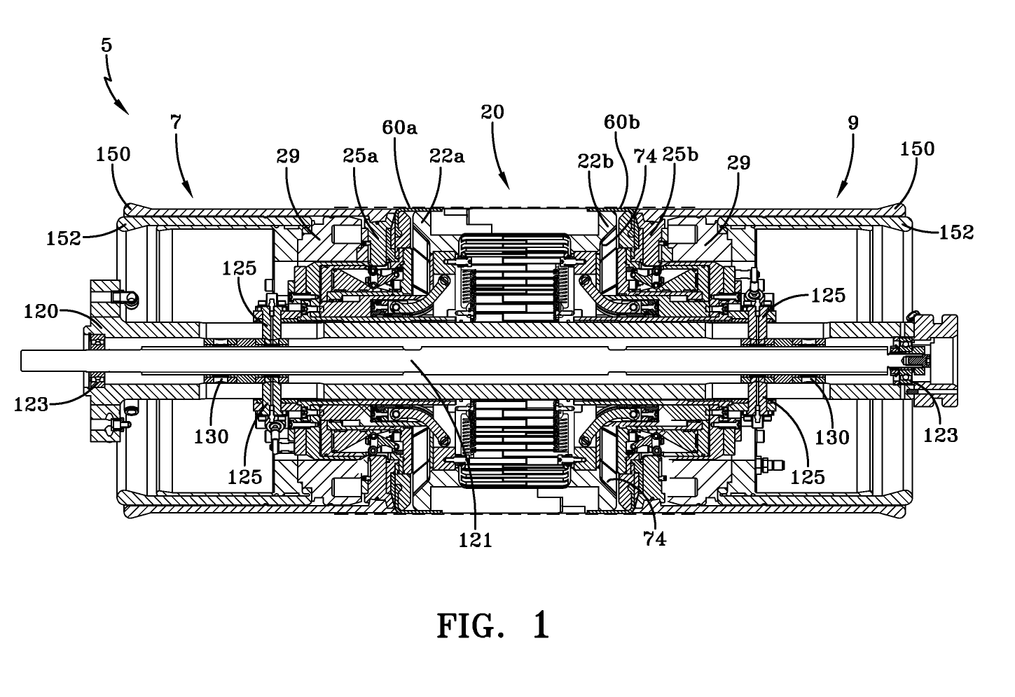

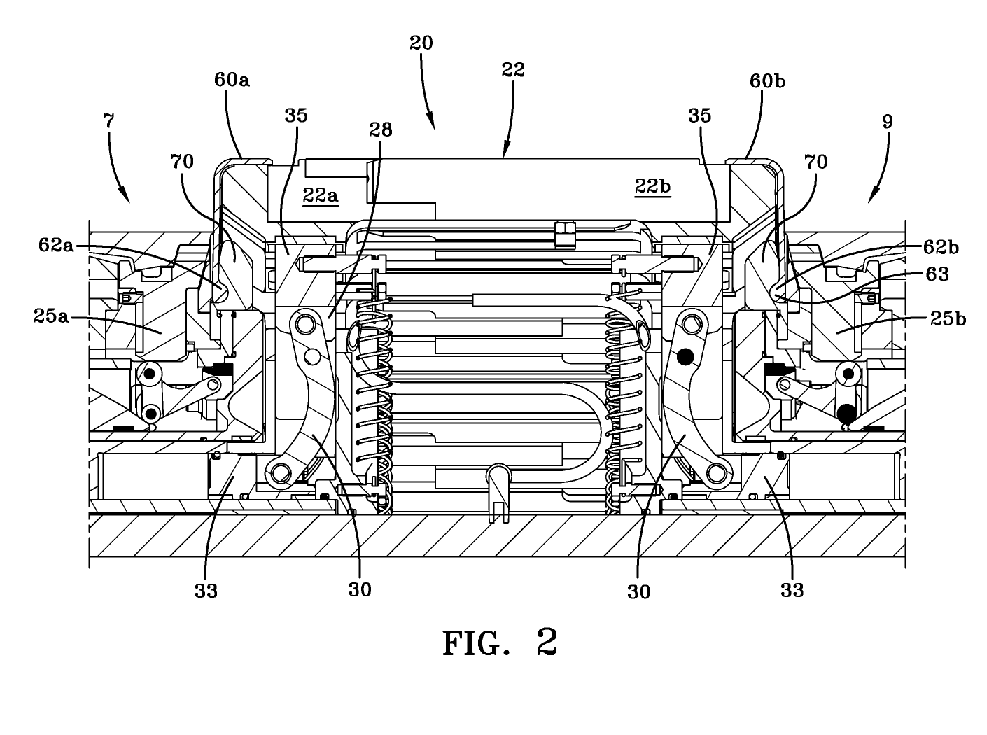

With reference to FIGS. 1 through 2, an exemplary tire building drum 5 of the present invention is illustrated. As shown more particularly in FIG. 1, the tire building drum 5 has a left hand side 7 and a right hand side 9 joined together by a center section 20. The center section is further divided into a right hand side 22b and a left hand side 22a, which are both axially and radially movable, as described in more detail, below. Adjacent the center section 20 are first and second bead locking mechanisms 25a,b, which are also radially movable as shown in FIG. 2. Adjacent the bead locking mechanisms are first and second shoulder sections 29. Both the bead locking mechanisms and the shoulder sections are axially movable. Thus, both the left hand side and the right hand side of the drum are axially movable. These components are described in more detail, below.

### Center Section

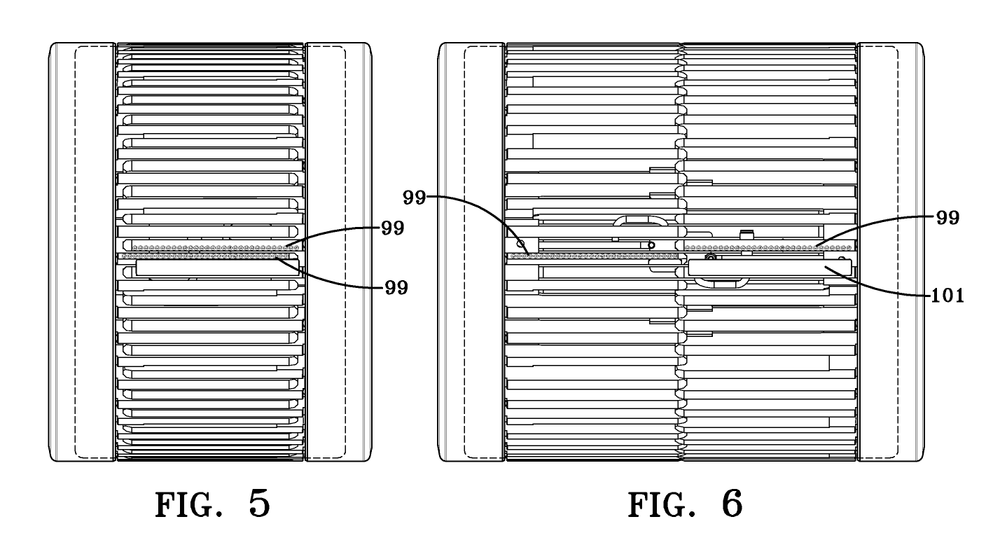

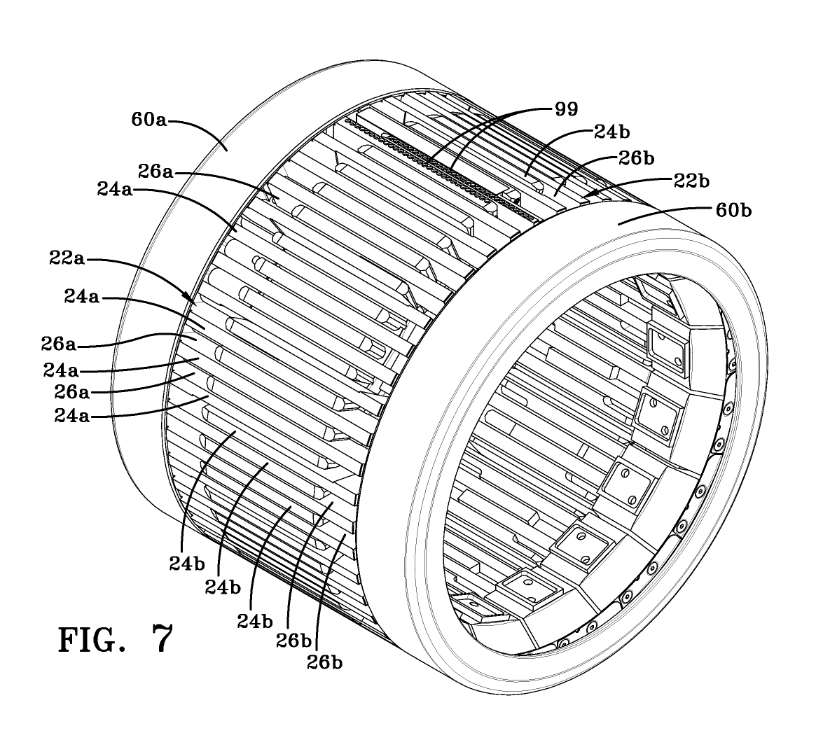

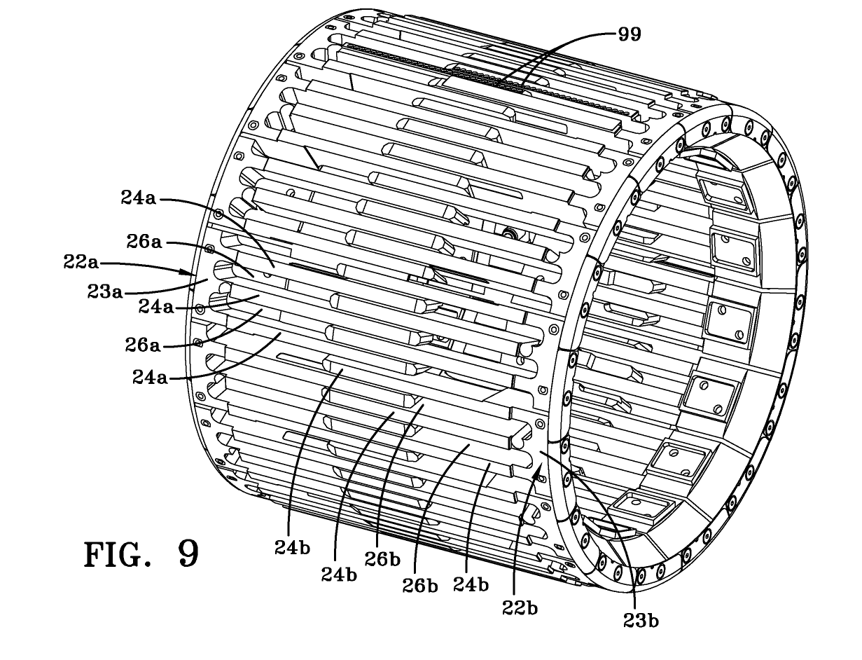

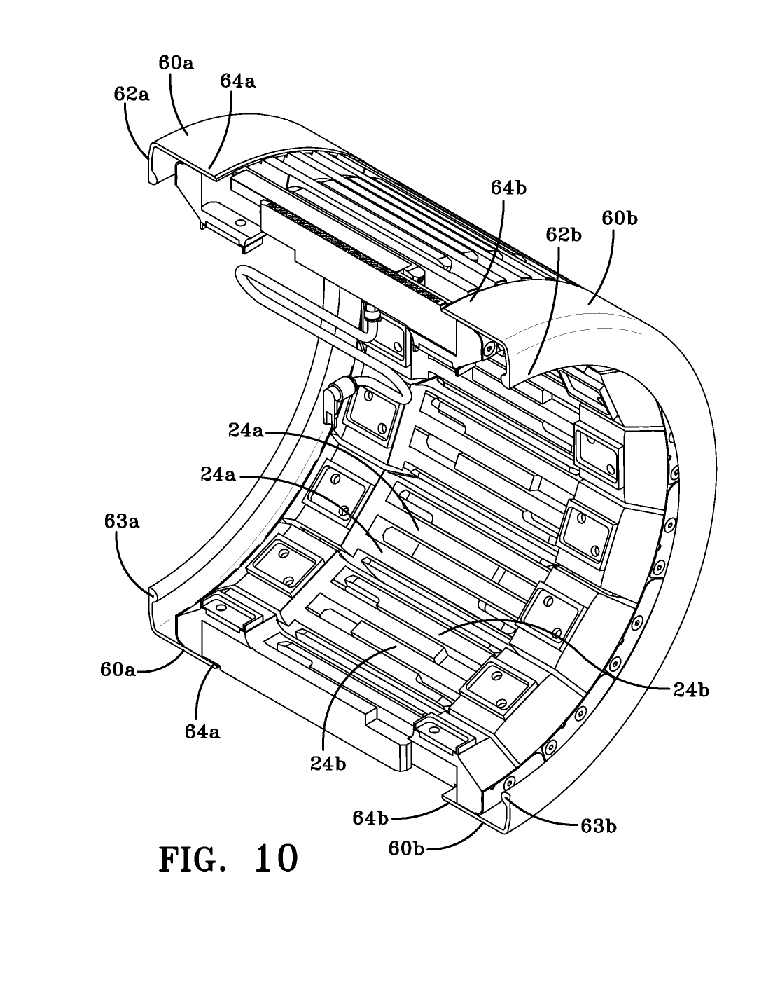

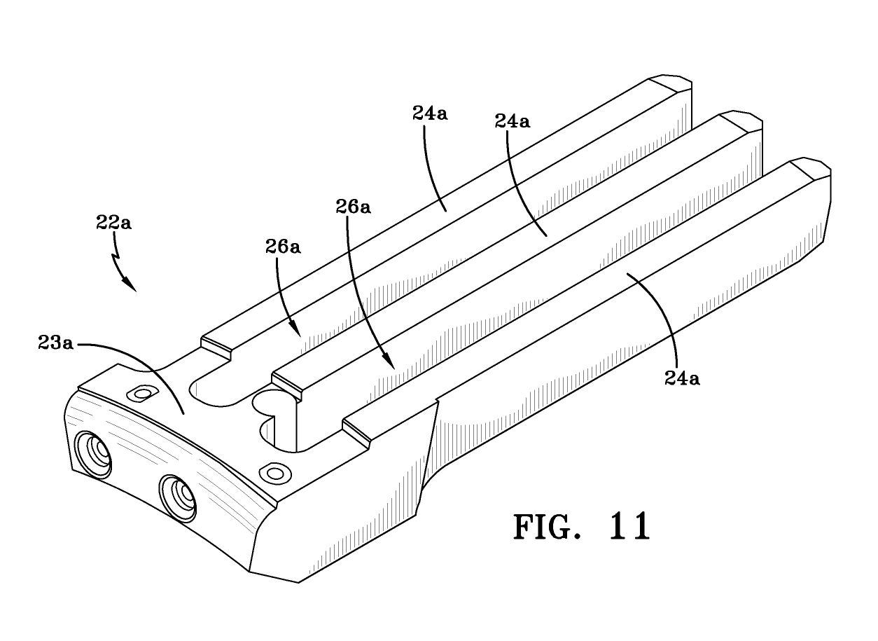

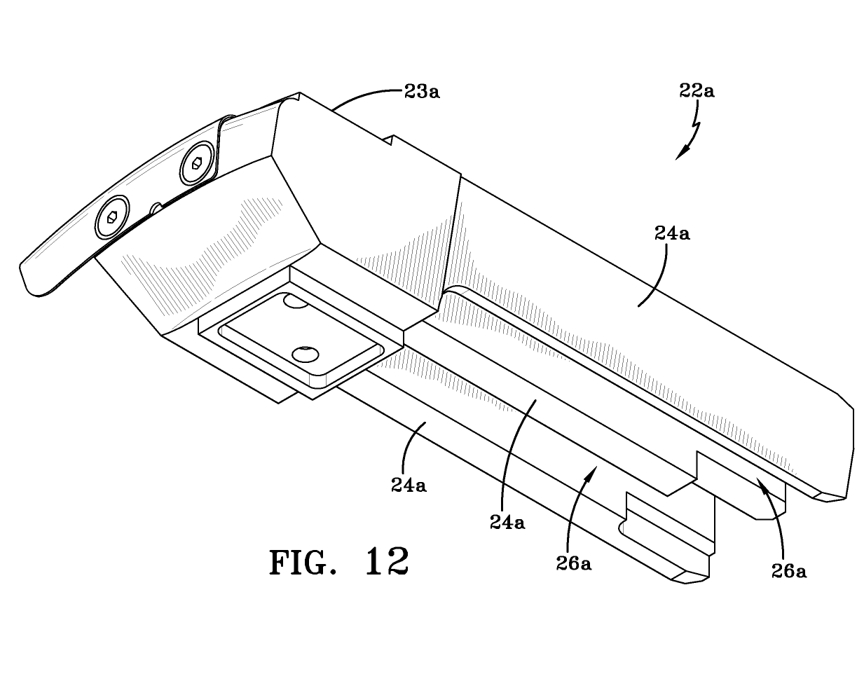

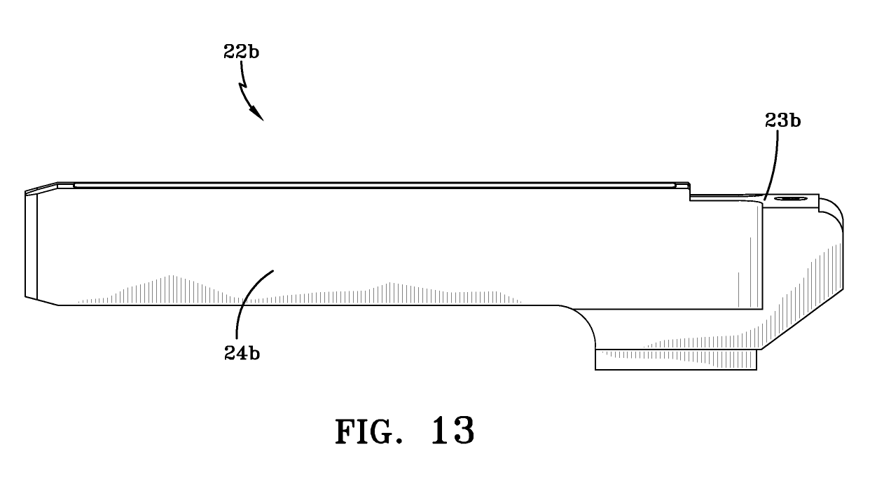

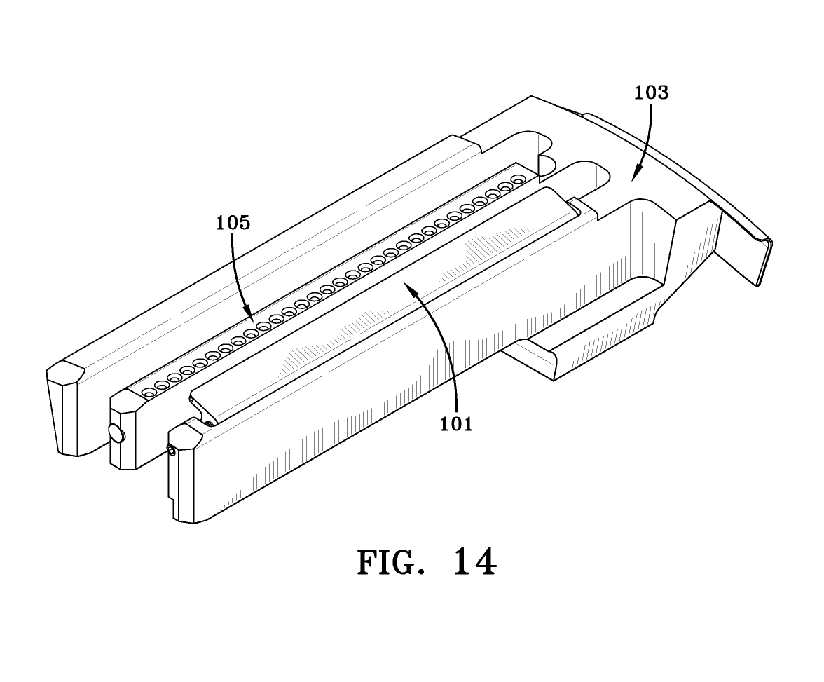

The center section 20 of the tire building drum as shown in FIGS. 2-10 further comprises a plurality of center segments 22a,b located about the outer circumference of the drum. Each of the center segments may be further split into a left hand side 22a and a right hand side 22b, as shown in FIGS. 4-12 (although not required). As shown in FIG. 11, the left hand side center segment 22a has one or more finger like projections 24a, with recesses 26a. The right hand side is the minor opposite. As shown in FIG. 10, left hand center segment 22a has three finger-like projections 24a which are slidably received in three elongate slots 26b in an interdigitated or interlocked manner. Likewise, right hand center segment 22b has three finger like projections 24b which are slidably received in three opposed elongate slots 26a. The center segments 22a,b thus cooperate with each other to axially expand or contract as the fingers slide within the recesses.

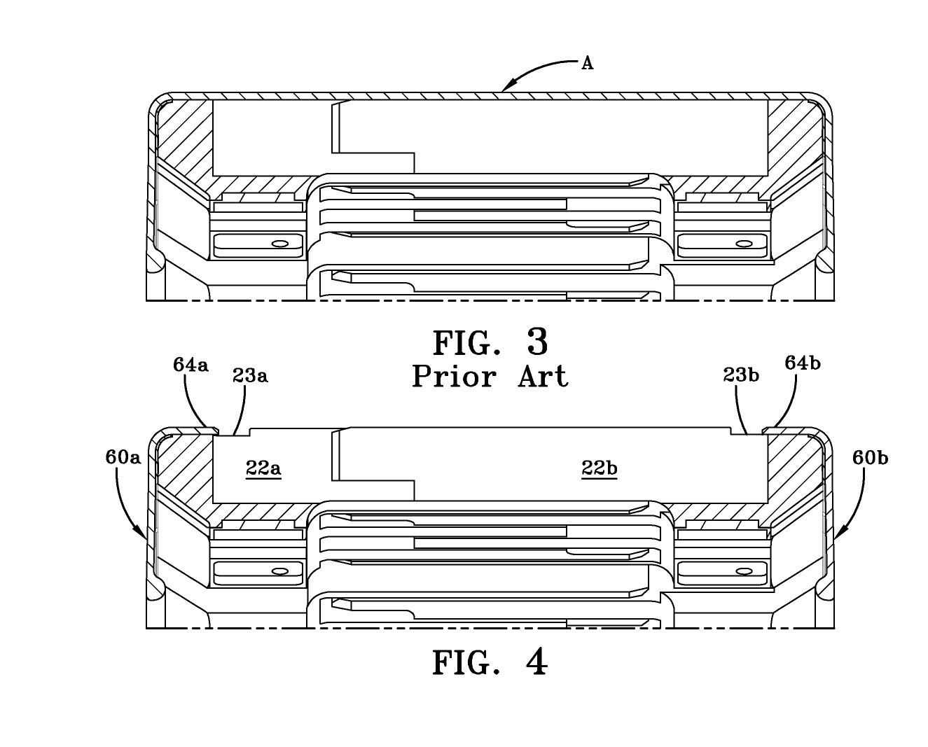

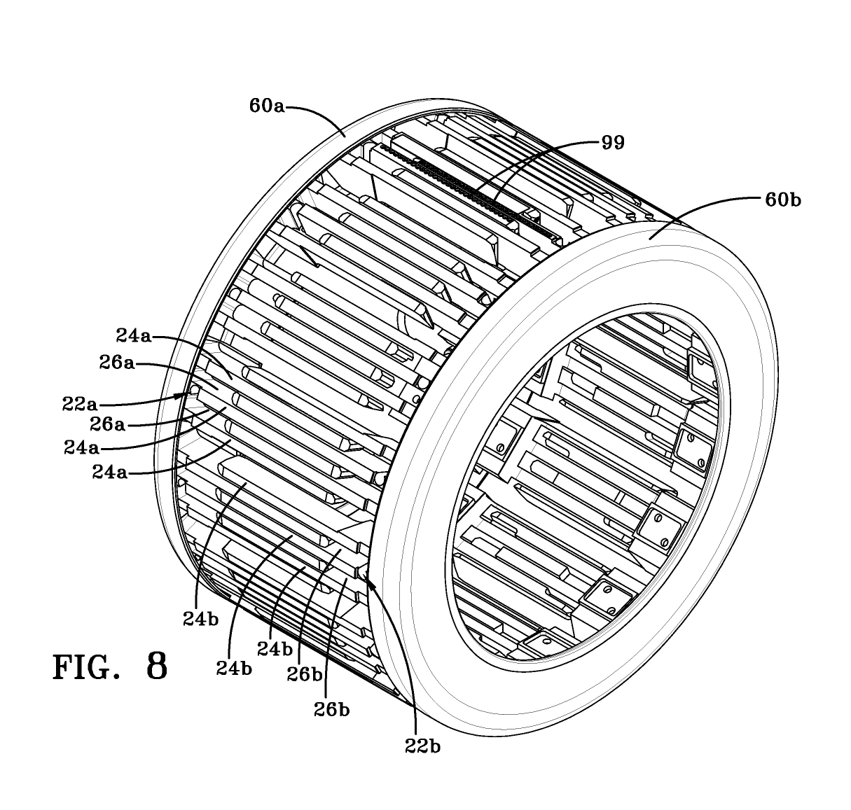

The center section 20 may also radially expand as shown in FIG. 8. The center section 20 can radially expand in the range of about 20 to about 50 mm. As each center segment 22a,b radially expands, the gap between the center segments increases. Provided within each center segment half 22a,b is a radially oriented piston chamber 28. Received in each chamber 28 is an elbow-shaped linkage 30 connected to a common actuator (not shown), such as a piston 33. A control system (not shown) actuates the pistons 33, causing linkage 30 to slide from the retracted position (not shown) to the actuated position shown in FIG. 3. When the linkages 30 are actuated, the linkages push the center segments radially outward into the high crown position as shown in FIG. 3.

### Shoulder Seals

FIG. 3 illustrates a typical tire building drum having a center section that is completely covered by a cylindrically shaped center sleeve A. The center sleeve A is typically comprised of thick rubber. The tire building drum of the present invention does not have a center sleeve, nor a sleeve or any type of rubber component that extends from one end of the center section to the other end, nor a sleeve that is located in the center of the center section of the drum. The tire building drum of the present invention has eliminated the center sleeve, and includes a first and second shoulder seal 60a,b. The purpose of the shoulder seals is to maintain the pneumatic seal between the bead of the green tire and the tire building drum, enabling inflation and shaping of the green tire in the full stage tire building process. The first and second shoulder seal 60a,b are located on the axially outer ends of the segments 22a,b forming the center section. Each center seal preferably has an overall annular shape, having a first end 62a,b which is secured in seal clamps 70 located adjacent the center section segments. Preferably the first ends 62a,b of the seal have an outer bead projection 63 for mating reception with inner protrusion of the seal clamp. The shoulder seals each further comprise a second end 64a,b that is a free or unconstrained end. Thus the shoulder seals are not subject to axial tension which substantially reduced the life of the center sleeve. The free end 64a,b rests on the outer surface 23a,b (FIG. 11) of the center segments 22a,b, and will slide relative to the center segments when the drum is radially expanded. The outer surface 23a,b has a smaller outer diameter than the center of the center section, forming a radial step so that when the shoulder seals are mounted, the shoulder seals form a flush surface with the center section of the drum.

Each shoulder seal may be cast in a mold (not shown) in the desired shape or as shown in FIG. 4. Preferably each seal is cast or formed in a “L” shape as shown. The seal may be made from rubber, polyurethane, or other flexible material.

The segments have been redesigned so that the innerliner is applied directly to the outer radial surface of the segments instead of the center sleeve. At least one finger of a segment (see FIGS. 5-7) is equipped with one or more vacuum holes 99 to enable fixing the leading edge of the innerliner to the drum using vacuum. Preferably, a finger of each of a left segment and a right segment is equipped with vacuum holes. FIG. 14 illustrates a special segment 103 with a splice bar plate 101. The special segment illustrates a finger 105 having a plurality of vacuum holes.

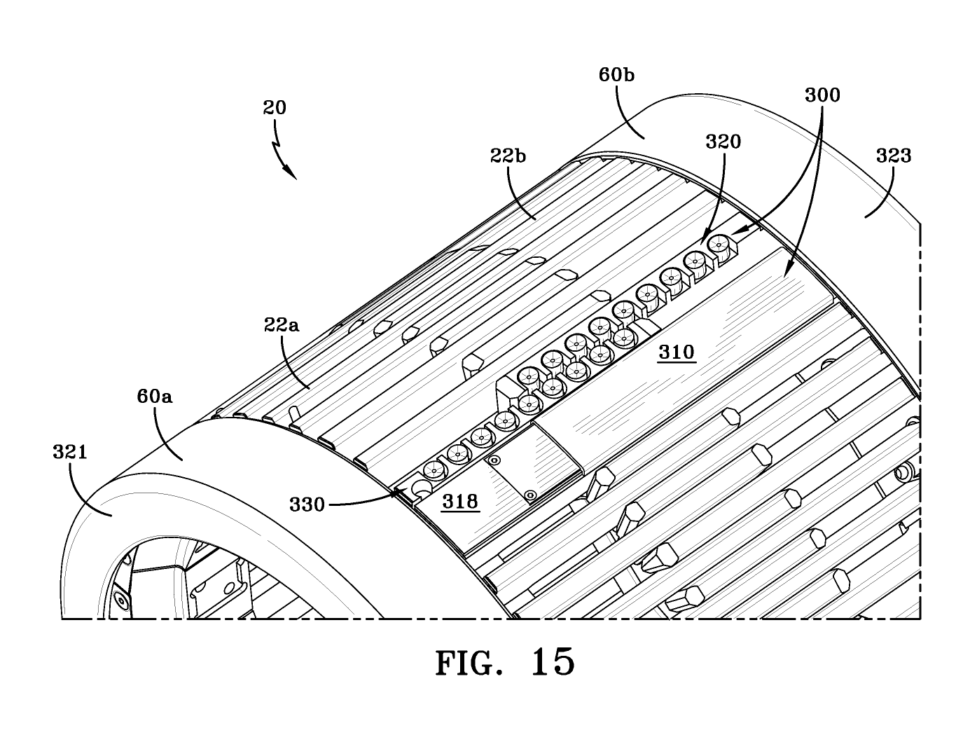

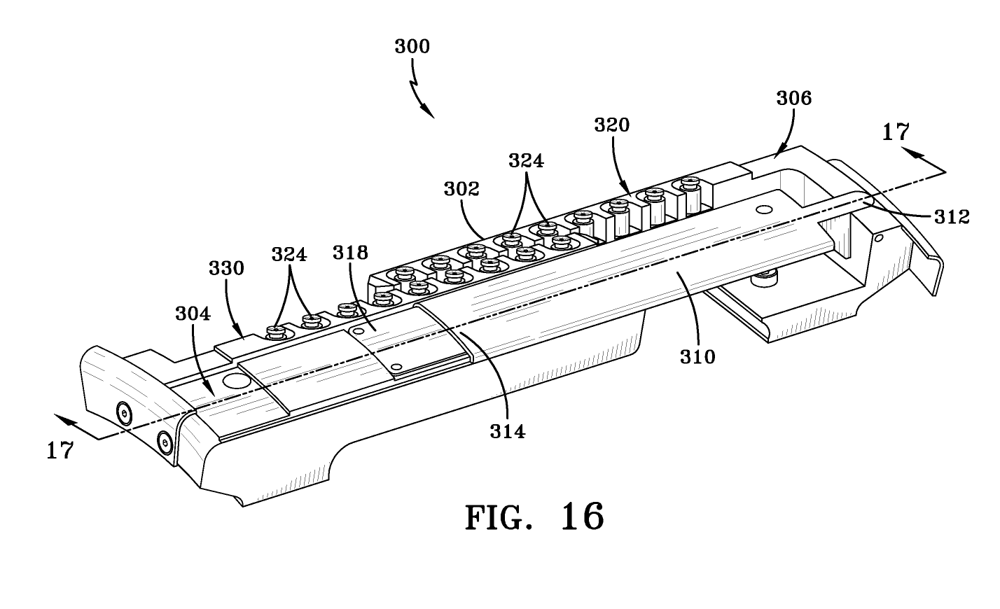

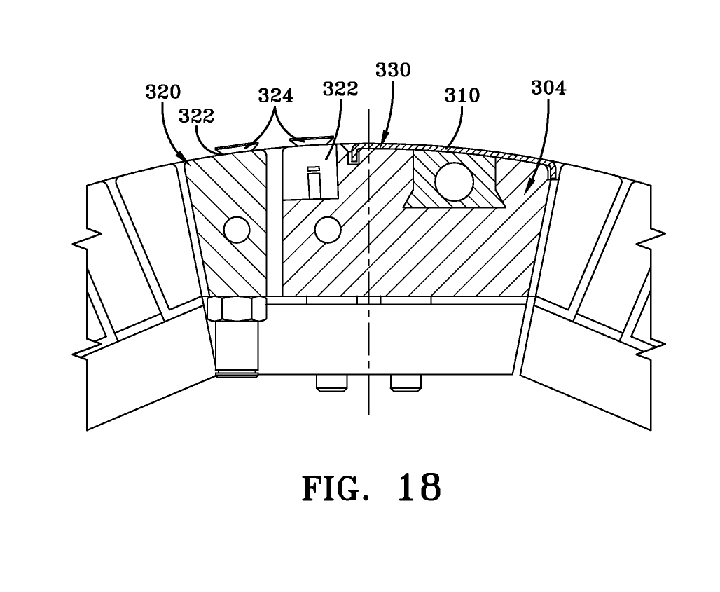

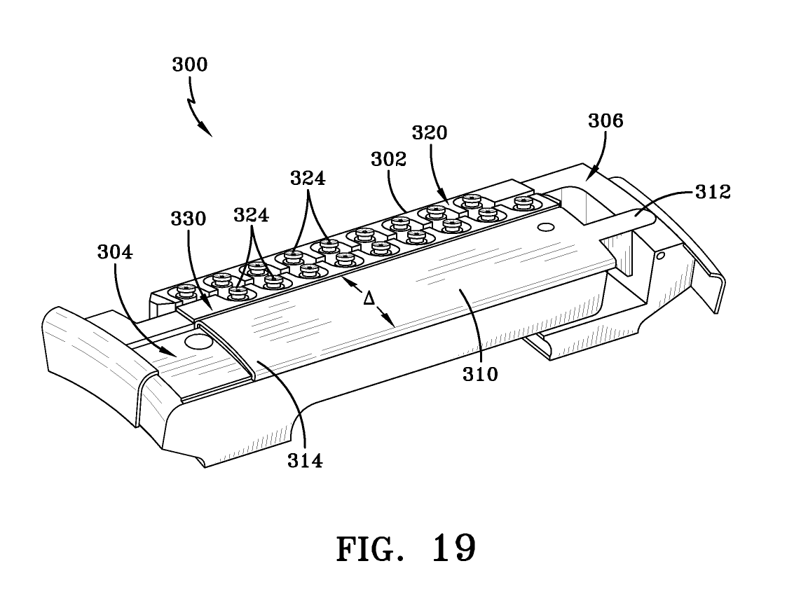

FIGS. 15-18 illustrate a second embodiment of a splice bar segment 300 with vacuum. In this embodiment, the segment 103 is replaced with the splice bar segment 300 on the tire building drum 5, as shown in FIG. 15. Unlike the segment 103, the splice bar 300 has a full axial width of the center section 20. Thus the splice bar extends from one axial end 321 to the opposite axial end 323 of the center section 20. Because the center section axially contracts as shown in FIG. 19, the slice bar 300 also axially contracts.

### Splice Bar Assembly

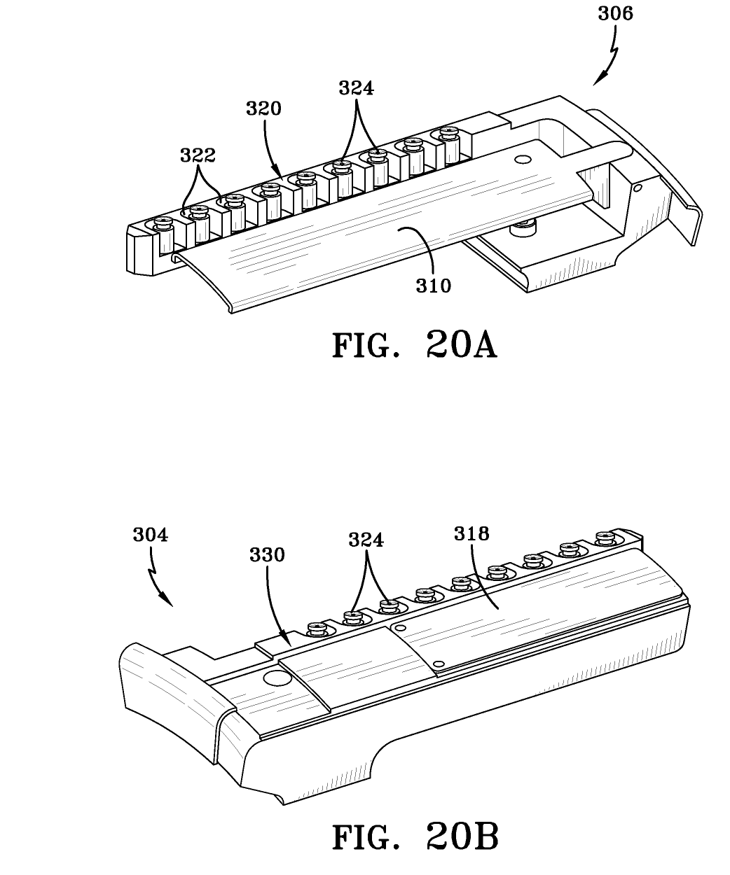

The splice bar 300 has a frame 302 having a left side 304 and a right side 306 that are slidable relative to each other, so that the splice bar 300 may axially expand or contract. As shown in FIG. 20a, the right side or first side frame 306 includes a rigid splice plate 310 and a vacuum bar 320 having a plurality of vacuum holes 322. The vacuum bar 320 is radially spaced apart from the rigid splice plate forming a radial gap so that a second vacuum bar 330 connected to the left side or second side frame 304 may be received therein. FIG. 20b illustrates the second side frame 304, which further includes a support plate 318 that is received under the rigid splice plate 310. Received in each vacuum hole is a resilient suction cup 324. The resilient suction cups 324 are preferably formed of elastomer, rubber, silicone or other resilient material. It is additionally preferred that the vacuum suction cups protrude from the vacuum holes 322 of the vacuum bars 320,330. The vacuum suction cups provide a larger surface area and better seal between the innerliner stock and the suction cups due to the resiliency and larger surface area. Preferably, there are 6-14 vacuum cups per vacuum bar 320,330.

The rigid splice plate 310 provides a surface having a sufficient radial depth D for supporting the leading edge of a tire component thereon, as well as providing a rigid surface support to allow the tire component to be spliced. The rigid splice plate 310 has a first end that is pivotally mounted to the right side 306 of the splice bar 300 at point 316. The rigid splice plate 310 has a free end 314 that is slidable over outer surface 318 of the left side 304 when the splice bar 300 axially contracts as shown in FIG. 19.

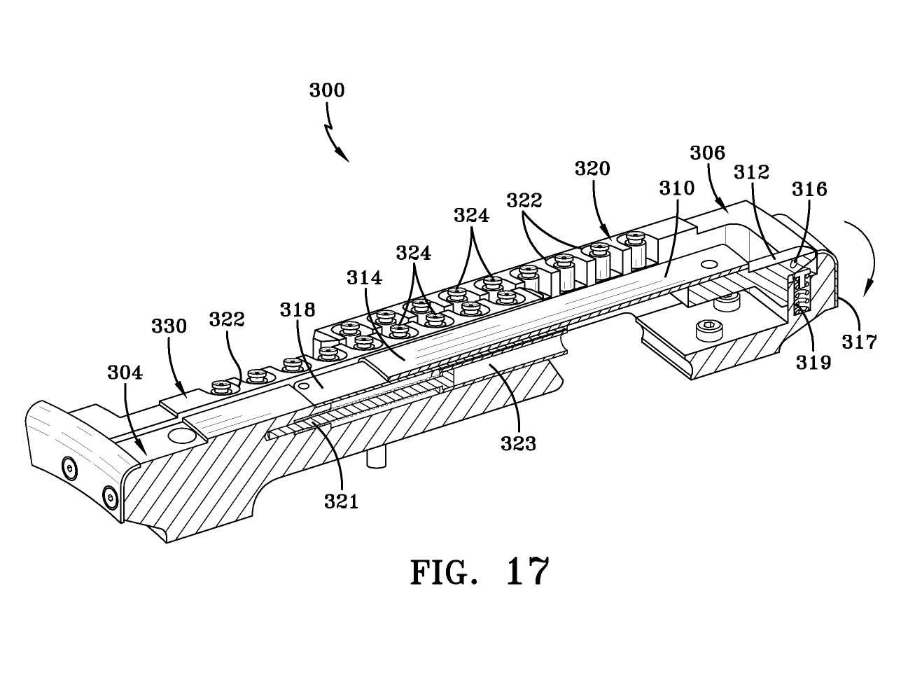

FIG. 17 illustrates a cutaway view of the splice bar 300. The splice plate 310 is rotatable about pivot point 316 in the direction shown in arrow 317. A compression spring 319 biases the spring in the closed position as shown. In the case of interference, the splice plate 310 will rotate about pivot point 316 so that the splice plate moves out of the way. The splice bar 300 further includes a second compression spring 321 that slides in sleeve 323. The second compression spring is oriented in the axial direction, and biases the splice bar 300 in the axially open position as shown.

### Bead Lock Mechanism

Adjacent the center section 20 are first and second annular bead locking mechanisms 25. The bead lock mechanism are radially expandable into a bead clamp position in order to secure the bead during the tire building process. FIG. 2 illustrates the bead locking mechanisms 25 in the retracted position.

### Shoulder Section and Shoulder Clamp Lock

The right and left hand shoulder section 29 of the tire building drum 5 is defined as the drum components located axially outward of the centerline of the center section, inclusive of the seal clamps and the bead lock mechanisms. The left and right hand shoulder sections of the tire building drum are axially slidable on bearing sleeves. The shoulder sections 29 are actuated by drive pins 125 mounted on nuts 130, which ride along drive screw 121. When the central screw is rotated, the nuts 130 move axially inward/outward, causing the drive pins 125 and each shoulder section to move axially inward/outward in corresponding fashion. In addition, the drive pins are also in mechanical cooperation with the split center segments, causing the split center segments 22a,b to axially extend or contract.

When the center section 20 of the tire building drum 5 moves into the high crown position as shown in FIG. 2, the bead lock mechanisms 25 and the seal clamp mechanism 70 are further actuated axially inward so that seal clamp is received in recess 74. The axial actuation of the bead lock mechanisms and seal clamps preferably occurs simultaneously with the movement of the center segments into the high crown position.

### Drive Shaft

A central drive shaft 120 is provided for rotational movement of the tire building drum 5 about its longitudinal axis. The central shaft 120 is connected to a drive means (not shown). Provided within the central drive shaft 120 is a central screw 121. The central screw 121 is supported at each end by bearings 123. The threads on one side of the central screw 121 are left handed and on the opposite side are right handed. On the left hand side is an inboard nut 125 connected to the one end of the threaded screw 121 and similarly on the opposite right hand side is an outboard ball nut 125 connected to the central screw 121.

### Turn Up Bladders

An upper bladder 150 extends axially outward from the bead lock mechanism 25 to the respective ends of the tire building drum. The upper bladder 150 extends over a lower bladder 152, which is mounted in the shoulder area of the drum and extends axially outward to the respective ends of the tire building drum. The upper and lower bladders function as turnup bladders which are used to inflate and, thereby, make the turn-up ends of the ply wrap about the apex and bead cores.

While certain representative embodiments and details have been shown for the purpose of illustrating the invention, it will be apparent to those skilled in this art that various changes and modifications may be made therein without departing from the spirit or scope of the invention.

What is claimed is:

1. A tire building drum comprising: a rotatable drum having a center section and a first and second shoulder section, said center section being radially expandable, wherein said center section has a first shoulder, a second shoulder and a center portion extending between the first and second shoulder, wherein the center section further comprising a first half and a second half, wherein the first half and the second half are axially movable with respect to each other; wherein the center section further comprises a rigid splice bar assembly, the assembly having a rotatable splice plate.

2. The tire building drum of claim 1 wherein the splice plate rotates about a direction transverse to the axial direction.

3. The tire building drum of claim 1 wherein the splice plate rotates about a radial axis.

4. The tire building drum of claim 1 wherein the splice plate pivots about one end.

5. The tire building drum of claim 1 wherein the center portion has no center sleeve.

6. The tire building drum of claim 1 wherein said center section further comprises a plurality of first half segments and a plurality of second half segments, wherein the first half segments are axially slidably relative to the second half segments.

7. The tire building drum of claim 1 wherein the center section further comprises a first and second shoulder seal positioned on the first and second shoulder, respectively.

8. The tire building drum of claim 1 wherein the rigid splice bar assembly is axially collapsible.

9. The tire building drum of claim 8 wherein a spring biases the rigid splice bar assembly into the axially open position.

10. The tire building drum of claim 1 wherein a compression spring biases the rotatable splice plate into the closed position.

11. The tire building drum of claim 1 wherein the splice plate has radial width greater than the radial width of the segment fingers.

12. The tire building drum of claim 1 wherein the splice plate has radial width greater than the radial width of at least two segment fingers.

13. The tire building drum of claim 1 wherein the rigid splice bar assembly further comprises a plurality of holes in fluid communication with a vacuum source.

14. The tire building drum of claim 13 wherein a resilient suction cup is positioned in a respective hole, wherein the suction cup has a hole for communicating vacuum fluid.

15. The tire building drum of claim 14 wherein the resilient suction cup protrudes from the hole.
